(19) United States
(12) Patent Application Publication
(10) Pub. No.: US 2018/0108009 A1
(43) Pub. Date: Apr. 19, 2018

(54) METHOD AND SYSTEM FOR SUPPLYING A TOKEN IN A HOST CARD EMULATION SYSTEM COMPRISING FIRST AND SECOND DEVICES

(71) Applicant: IDEMIA IDENTITY & SECURITY FRANCE, Issy Les Moulineaux (FR)

(72) Inventors: Naama BAK, Issy Les Moulineaux (FR); Cyrille PEPIN, Issy Les Moulineaux (FR); Jérôme CHAVANEL, Issy Les Moulineaux (FR)

(73) Assignee: IDEMIA IDENTITY & SECURITY FRANCE, Issy Les Moulineaux (FR)

(21) Appl. No.: 15/783,408

(22) Filed: Oct. 13, 2017

(30) Foreign Application Priority Data
Oct. 14, 2016 (FR) 16/59972

(51) Int. Cl. G06Q 20/36; G06Q 20/38; G06Q 20/02

(52) U.S. Cl. CPC G06Q 20/3674; G06Q 20/02; G06Q 20/382; G06Q 20/385

(57) ABSTRACT

The invention relates to a method and system for supplying a token in a host card emulation system comprising first and second devices and a secure payment platform, the method comprises the steps of transfer by the second device to the first device an identifier of the second device, reception by the second device of a first token and an identifier of the second device, the first token being a symmetrical derivation of a second token of the first device with the identifier of the second device, transfer by the second device of a message comprising a cryptogram signed with the first token, the identifier of the first device and predetermined information indicating that the first token has been transferred by a third party.

The present invention relates to a method and system for providing a token in a host card emulation system.

Electronic devices able to communicate by means of telecommunication links now integrate more and more functionalities.

For example, payment by means of a smartphone, although being able to raise certain concerns, is developing. For this, authentication and security functions must be used for financial transactions from smartphones.

Payment by means of a smartphone or by means of any other electronic device able to communicate by means of a telecommunication link is a functionality that tends to develop in the future. The authentication and security functions are adapted to replace conventional cards such a credit cards, debit cards, loyalty cards, travel cards, etc.

Smartphones are now provided with a portfolio and now allow contactless payment (NFC, the acronym for near field communication”) by means of the provision of specific account information in a secure field of the smartphone.

Recently, host card emulation has been proposed and used for allowing such banking transactions.

HCE Service supplies not only the product but also the service, including an infrastructure for managing dematerialised remote transactions.

A token-management mechanism makes it possible to make payments with an NFC-compatible mobile telephone in order to communicate with a payment terminal compatible with the contactless EMV standard.

The tokens are transmitted and stored in a secure manner in the mobile telephone. These tokens are used to authenticate the user and the appliance, and for making the transmission secure. The tokens contain the information necessary for contactless payment via the NFC interface of the smartphone.

An electronic device able to communicate by means of a telecommunication link is, for example, a smartphone that has a limited number of tokens. In some cases, it is not possible for the user of the smartphone to obtain new tokens when he no longer has any tokens. This is for example the case when he is in an area in which access to a telecommunication network is not possible. It then becomes impossible to make bank transactions with the smartphone.

The aim of the present invention is to solve the problems of the prior art by proposing a method and system that enable a device to make bank transactions in an HCE system by means of a device not having any tokens.

To this end, according to a first aspect, the invention proposes a method for supplying a token in a host card emulation system comprising first and second devices and a secure payment platform, characterised in that the method comprises the steps of:
transferring by the second device to the first device an identifier of the second device and/or of the user of the second device,
receiving from the first device by the second device a first token and an identifier of the second device and/or of the user of the second device, the first token being a symmetrical derivation of a second token of the first device with the identifier of the second device and/or of the user of the second device,
transferring by the second device a message comprising a cryptogram signed with the first token, the identifier of the first device and/or of the user of the first device and predetermined information indicating that the first token has been transferred by a third party,
receiving the message by the dematerialised payment platform,
obtaining by the dematerialised payment platform information relating to the first device and/or the user of the first device for generation of a third token of the first device,
generating a cryptogram by the dematerialised platform by effecting a symmetrical key derivation of the third token generated by the dematerialised platform with the identifier of the second device (20) and/or of the user of the second device,
accepting the bank transaction if the cryptograms are identical.

The invention also relates to a system for supplying a token in a host card emulation system comprising first and second devices and a secure payment platform, characterised in that the system comprises:
means for transferring by the second device to the first device an identifier of the second device and/or of the user of the second device,
means for receiving from the first device by the second device a first token and an identifier of the second device and/or of the user of the second device, the first token being a symmetrical derivation of a second token of the first device with the identifier of the second device and/or of the user of the second device,
means for transferring by the second device a message comprising a cryptogram signed with the first token, the identifier of the first device and/or of the user of the first device and predetermined information indicating that the first token has been transferred by a third party,
means for receiving the message by the dematerialised payment platform,
means for obtaining by the dematerialised payment platform information relating to the first device and/or of the user of the first device for generation of a third token of the first device,
means for generating a cryptogram by the dematerialised platform by executing a symmetrical key derivation of the third token generated by the dematerialised platform with the identifier of the second device (20) and/or of the user of the second device,
means for the accepting the bank transaction if the cryptograms are identical.

Thus a device can make bank transactions in an HCE system even if it does not have any tokens.

According to a particular embodiment of the invention, the message comprising the cryptogram signed with the first token is transferred to a retail outlet terminal, which interrogates a server of a bank establishment, which in its turn interrogates the dematerialised payment platform in order to verify the cryptogram.

According to a particular embodiment of the invention, the predetermined information indicating that the first token has been transferred by a third party also indicates that the account of the user of the second device must be debited.

According to a particular embodiment of the invention, the predetermined information indicating that the first token has been transferred by a third party further indicates that the account of the user of the second device must be debited and that the account of the user of the first device must be credited.

According to a particular embodiment of the invention, the predetermined information indicating that the first token has been transferred by a third party further indicates the amount of debit and credit.

According to a particular embodiment of the invention, the method further comprises, the step executed prior to the step of transfer by the second device to the first device of an identifier of the second device and/or of the user of the second device, of creation of a secure channel between the first and second device, and the identifier of the second device and the first token are transferred in the secure channel.

According to a particular embodiment of the invention, the first and second devices are smartphones.

The features of the invention mentioned above, as well as others, will emerge more clearly from a reading of the following description of an example embodiment, said description being given in relation to the accompanying drawings, among which:

FIG. 1 shows a host card emulation system with transfer of tokens in which the present invention is implemented;

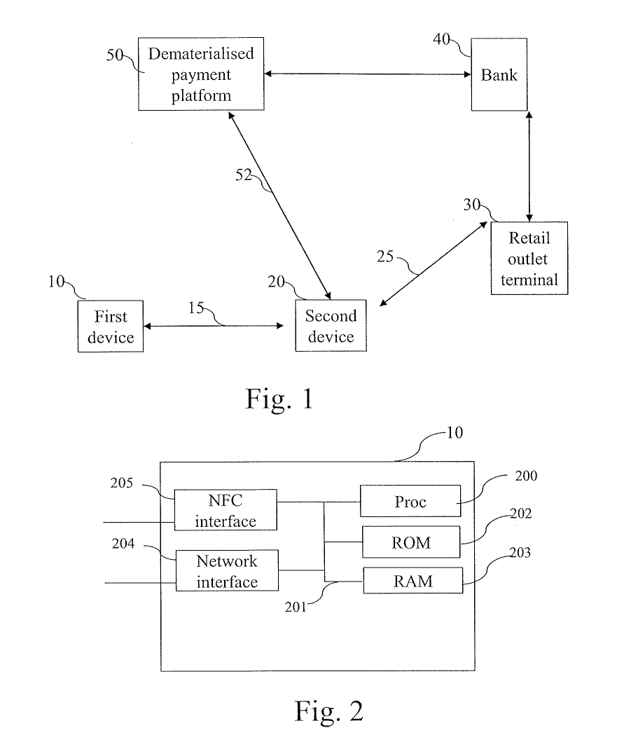

FIG. 2 shows an example of architecture of a first device in which the present invention is implemented;

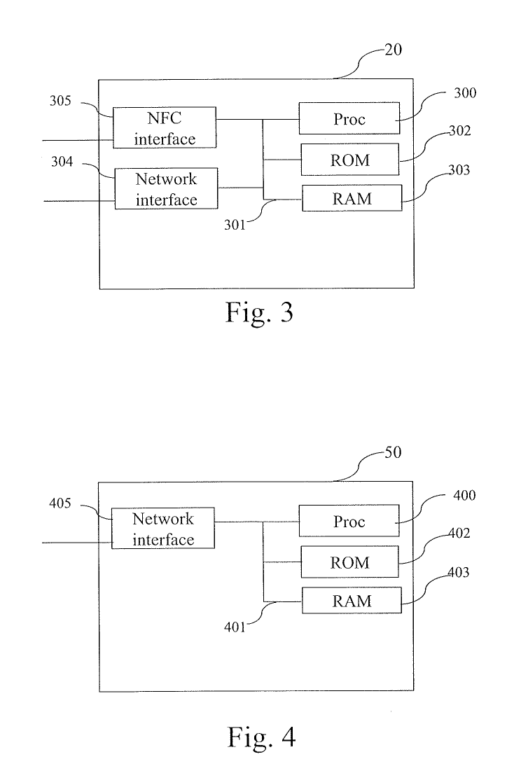

FIG. 3 shows an example of architecture of a second device in which the present invention is implemented;

FIG. 4 shows an example of architecture of a dematerialised payment platform in which the present invention is implemented;

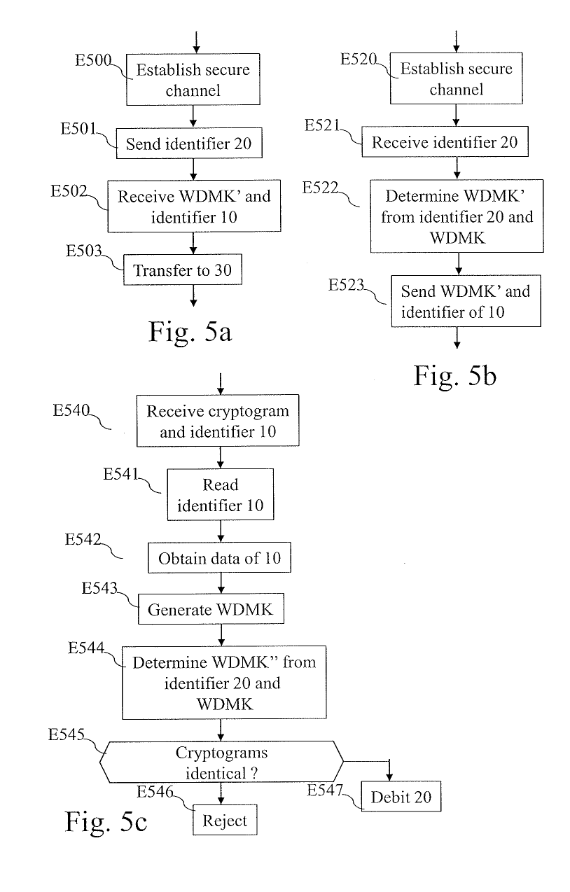

FIG. 5a shows an example of an algorithm executed by the second device according to a first embodiment of the present invention;

FIG. 5b shows an example of an algorithm executed by the first device according to the first embodiment of the present invention;

FIG. 5c shows an example of an algorithm executed by the dematerialised payment platform according the first embodiment of the present invention;

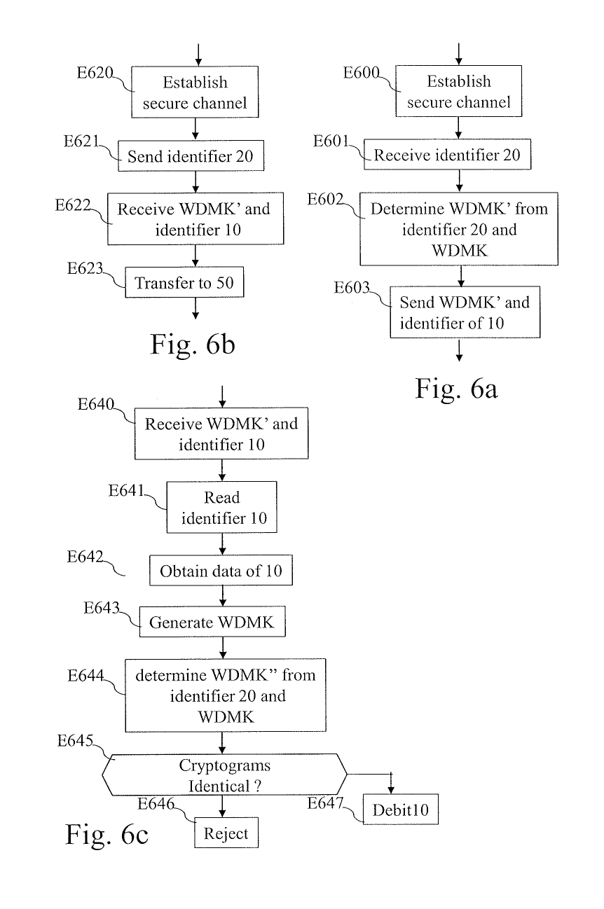

FIG. 6a shows an example of an algorithm executed by the first device according to a second embodiment of the present invention;

FIG. 6b shows an example of an algorithm executed by the second device according to the second embodiment of the present invention;

FIG. 6c shows an example of an algorithm executed by the dematerialised payment platform according the second embodiment of the present invention;

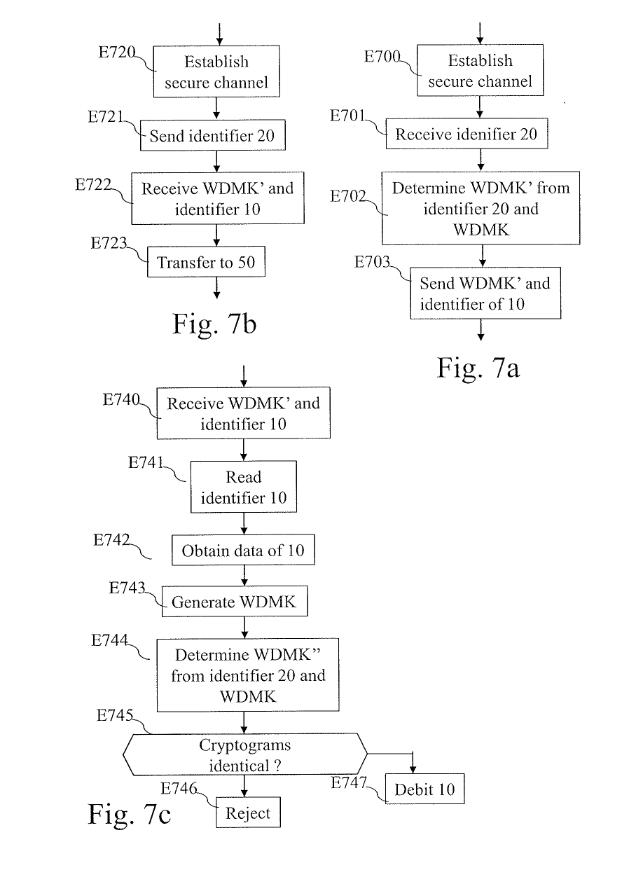

FIG. 7a shows an example of an algorithm executed by the first device according to a third embodiment of the present invention;

FIG. 7b shows an example of an algorithm executed by the second device according to the third embodiment of the present invention;

FIG. 7c shows an example of an algorithm executed by the dematerialised payment platform according the third embodiment of the present invention;

FIG. 1 shows a system for transferring host card emulation tokens in which the present invention is implemented.

A payment system based on card emulation conventionally comprises at least one first device 10, a retail outlet terminal 30, a financial body such as a bank 40 and a dematerialised payment platform 50.

Conventionally, when a user of the first device 10, such as for example a smartphone, wishes to make a payment at a retail outlet terminal 30 by means of the first device 10 in accordance with the card emulation system, the user of the first device 10 transfers a cryptogram signed by a token to the retail outlet terminal 30. The retail outlet terminal interrogates a server 40 of the bank of the user of the first device 10, which in its turn interrogates a dematerialised payment platform 50 in order to check the integrity of the data. If the check proves positive, the transaction is validated.

According to a first embodiment of the present invention, when the user of the second device 20 no longer has a token and cannot obtain one, he obtains a token 15 from the first device 10 and makes the payment 25 at the retail-outlet terminal 30 by means of the second device 20. The first device 10 is for example a smartphone of a friend or a member of his family. The second device is for example a smartphone.

A token according to the invention makes it possible to authenticate the user, the second device and information to carry out the transaction like for example, the amount of the transaction.

Token is more safe than a simple authentication of the user.

According to a second embodiment of the present invention, when the user of the first device 10 wishes to transfer a sum of money to a friend or to a member of his family, the user of the first device 10 transfers a token 15 with the amount of the sum of money to the second device 20, which transfers a cryptogram 52 signed by the token to the dematerialised payment platform 50, which checks the integrity of the data of the cryptogram for validation of the money transfer by the bank 40 of the user of the first device 10. The second device 20 is for example a smartphone of a friend or a member of his family.

The first device is for example a smartphone.

According to a third embodiment of the present invention, when the user of the first device 10 wishes to validate a payment for a device 20 not having a token, the user of the first device 10 transfers a token 15 to the second device 20, which transfers a cryptogram 52 signed by the token to the dematerialised payment platform 50, which checks the integrity of the data of the token for validation of the transfer of money by the bank 40 of the user of the first device 10. The second device 20 is for example a television set, or a domestic gateway connected to a television set.

The first device is for example a smartphone.

FIG. 2 shows an example of architecture of a first device in which the present invention is implemented.

The first device 10 comprises:
a processor, microprocessor, or microcontroller 200;
a volatile memory 203;
a non-volatile memory 202;
an NFC interface 205;
a cellular communication network interface 204;
a communication bus 201 connecting the processor 200 to the ROM memory 202, to the RAM memory 203, to the NFC interface 205 and to the cellular communication network interface 204.

The processor 200 is capable of executing instructions loaded into the volatile memory 203 from the non-volatile memory 202, from an external memory (not shown), from a storage medium such as an SD card or the like, or from a communication network. When the first device 10 is powered up, the processor 200 is capable of reading instructions from the volatile memory 203 and executing them. These instructions form a computer program that causes the implementation, by the processor 200, of all or part of the method described in relation to FIGS. 5b and/or 6a and/or 7a.

All or part of the method described in relation to FIGS. 5b and/or 6a and/or 7a can be implemented in software form by the execution of a set of instructions by a programmable machine such as a DSP (digital signal processor) or a microcontroller, or be implemented in hardware form by a machine or a dedicated component such as an FPGA (field-programmable gate array) or an ASIC (application-specific integrated circuit).

FIG. 3 shows an example of architecture of a first device in which the present invention is implemented.

The second device 20 comprises:
a processor, microprocessor, or microcontroller 300;
a volatile memory 303;
a non-volatile memory 302;
an NFC interface 305;
a cellular communication network interface 304;
a communication bus 301 connecting the processor 300 to the ROM memory 302, to the RAM memory 303, to the NFC interface 305 and to the cellular communication network interface 304.

The processor 300 is capable of executing instructions loaded into the volatile memory 303 from the non-volatile memory 302, from an external memory (not shown), from a storage medium such as an SD card or the like, or from a communication network. When the second device 20 is powered up, the processor 300 is capable of reading instructions from the volatile memory 303 and executing them. These instructions form a computer program that causes the implementation, by the processor 300, of all or part of the method described in relation to FIGS. 5a and/or 6b and/or 7b.

All or part of the method described in relation to Figs. FIGS. 5a and/or 6b and/or 7b can be implemented in software form by the execution of a set of instructions by a programmable machine such as a DSP (digital signal processor) or a microcontroller, or be implemented in hardware form by a machine or a dedicated component such as an FPGA (field-programmable gate array) or an ASIC (application-specific integrated circuit).

FIG. 4 shows an example of architecture of a dematerialised payment platform in which the present invention is implemented.

The dematerialised payment platform 50 comprises:
a processor, microprocessor, or microcontroller 400;
a volatile memory 403;
a non-volatile memory 402;
a cabled and/or cellular network interface 405;
a communication bus 401 connecting the processor 400 to the ROM memory 402, to the RAM memory 403 and to the network interface 405.

The processor 400 is capable of executing instructions loaded into the volatile memory 403 from the non-volatile memory 402, from an external memory (not shown), from a storage medium such as an SD card or the like, or from a communication network. When the dematerialised payment platform 50 is powered up, the processor 400 is capable of reading instructions from the volatile memory 403 and executing them. These instructions form a computer program that causes the implementation, by the processor 400, of all or part of the method described in relation to FIGS. 5c and/or 6c and/or 7c.

All or part of the method described in relation to FIGS. 5c and/or 6c and/or 7c can be implemented in software form by the execution of a set of instructions by a programmable machine such as a DSP (digital signal processor) or a microcontroller, or be implemented in hardware form by a machine or a dedicated component such as an FPGA (field-programmable gate array) or an ASIC (application-specific integrated circuit).

FIG. 5a shows an example of an algorithm executed by the second device according to a first embodiment of the present invention.

When the user of the second device 20 wishes to receive a token from a third party having the first device 10, he controls the device 20 in order to establish at step E500 a secure channel between the first and second devices 10 and 20 for example by means of the NFC interfaces 205 and 305 or interfaces 204 and 304.

The secure channel is for example based on the sharing of the same symmetrical key to open a secure session of the SCP02 or SCP03 type.

At step E501, at least one identifier of the second device 20 and/or of the user of the device 20 is transferred to the first device 10 by means of the secure channel.

At step E502, a token denoted WDMK′ and at least one identifier of the first device 10 and/or of the user of the first device 10 is received by means of the secure channel.

At step E503, a message comprising a cryptogram signed by the token denoted WDMK′, the identifier of the second device 20 and/or of the user of the second device 20 and the identifier of the first device 10 and/or of the user of the first device 10 is transferred to the retail outlet terminal 30 in order to make a payment.

The message comprises an application data field of the bank that comprises predetermined information indicating that the token WDMK′ has been transferred by a third party, in this case the user of the second device 20 in the present example. The predetermined information also indicates that the bank account of the user of the second device 20 must be debited.

The retail outlet terminal 30 interrogates a server 40 of the bank of the user of the device 20, which in its turn interrogates a dematerialised payment platform 50 in order to check the integrity of the data.

FIG. 5b shows an example of an algorithm executed by the first device according to the first embodiment of the present invention.

When the user of the first device 10 wishes to transfer a token to a third party having the second device 20, the latter controls the device 10 in order to establish at step E520 a secure channel between the first and second devices 10 and 20 for example by means of the NFC interfaces 205 and 305 or the interfaces 204 and 304.

The secure channel is for example based on the sharing of the same symmetrical key to open a secure session of the SCP02 or SCP03 type.

At step E521, the first device 10 receives from the second device 20 at least one identifier of the second device 20 and/or of the user of the second device 20 by means of the secure channel.

At step E522, the first device 10 determines, from a WDMK token available to it, a new token WDMK′ by effecting a symmetrical key derivation of the token WDMK with the identifier of the second device 20 and/or of the user of the second device 20.

For example, the first device 10 makes a 3DES key derivation taking as parameters the identifier of the second device 20 and the data of the transaction if they are supplied.

At step E523, the first device 10 demands the transfer of the token WDMK′ by means of the secure channel to the second device 20.

FIG. 5c shows an example of an algorithm executed by the dematerialised payment platform according to the first embodiment of the present invention.

At step E540, the dematerialised payment platform 50 receives, from a retail outlet terminal 30 by means of the server 40, a message comprising a cryptogram signed by the token denoted WDMK′, the identifier of the second device 20 and/or of the user of the second device 20 as well as the identifier of the first device 10 and/or of the user of the first device 10 is transferred to the retail outlet terminal 30 in order to make a payment.

The message comprises an application data field of the bank that contains predetermined information indicating that the token WDMK′ has been transferred by a third party, in this case the user of the second device 20 in the present example. The predetermined information also indicates that the bank account of the user of the second device 20 must be debited.

At step E541, the dematerialised payment platform 50 reads the identifier of the first device 10 and/or of the user of the first device 10 as well as the predetermined information indicating that the token WDMK′ has been transferred by a third party and that the bank account of the user of the second device 20 must be debited.

At step E542, the dematerialised payment platform 50 interrogates a database comprising information relating to the first device 10 and/or to the user of the first device 10.

The information relating to the first device 10 and/or to the user of the first device 10 makes it possible to obtain the information necessary for generating the token WDMK of the first device 10 and/or of the user of the first device 10.

At step E543, the dematerialised payment platform 50 generates a token WDMK from the information obtained from the database.

At step E544, the dematerialised payment platform 50, from the token WDMK generated at step E543, determines a token WDMK′ by effecting a symmetrical derivation of the token WDMK with the identifier of the second device 20 and/or of the user of the second device 20.

At step E545, the dematerialised payment platform 50 checks whether the cryptogram received and signed with the token WDMK′ and the cryptogram signed with the token WDMK″ are identical.

If the cryptograms are identical, the transaction is validated at step E547 and the account of the user of the second device 20 is debited.

If the cryptograms are different, the transaction is rejected at step E546.

FIG. 6a shows an example of an algorithm executed by the first device according to a second embodiment of the present invention.

When the user of the first device 10 wishes to pay a sum of money to a third party having the second device 20, he controls the device 10 in order to establish at step E600 a secure channel between the first and second devices 10 and 20, for example by means of the NFC interfaces 205 and 305 or the interfaces 204 and 304.

The secure channel is for example based on the sharing of the same symmetrical key to open a secure session of the SCP02 or SCP03 type.

At step E601, the first device 10 receives from the second device 20 at least one identifier of the second device 20 and/or of the user of the second device 20 by means of the secure channel.

At step E602, the first device 20, from a token WDMK that he has, determines a new token WDMK′ by effecting a symmetrical key derivation of the token WDMK with the identifier of the second device 20 and/or of the user of the second device 20.

At step E603, the first device 10 demands transfer of the token WDMK′ by means of the secure channel to the second device 20 as well as the identifier of the first device 10 and/or of the user of the first device 10.

FIG. 6b shows an example of an algorithm executed by the second device according to the second embodiment of the present invention.

When the user of the second device 20 wishes to receive a sum of money from a third party having the first device 10, he controls the second device 20 in order to establish at step E620 a secure channel between the first and second devices 10 and 20, for example by means of the NFC interface 205 and 305 or interfaces 204 and 304.

The secure channel is for example is based on the sharing of the same symmetrical key to open a secure session of the SCP02 or SCP03 type.

At step E621, at least one identifier of the second device 20 and/or of the user of the second device 20 is transferred to the device 10 by means of the secure channel.

At step E622, a token denoted WDMK′ and at least one identifier of the first device 10 and/or of the user of the first device 10 is received by means of the secure channel.

At step E623, a message comprising a cryptogram signed by the token denoted WDMK′, the identifier of the second device 20 and/or of the user of the second device 20 as well as the identifier of the first device 10 and/or of the user of the first device 10 is transferred to the dematerialised payment platform 50.

The message comprises an application data field of the bank that comprises predetermined information indicating that the token WDMK′ has been transferred by a third party, in this case the user of the first device 10 in the present example. The predetermined information also indicates that the bank account of the user of the second device 20 must be debited and that the bank account of the user of the second device 20 must be credited and, optionally, the amount to be credited and debited.

FIG. 6c shows an example of an algorithm executed by the dematerialised payment platform according to the second embodiment of the present invention.

At step E640, the dematerialised payment platform 50 receives from the second device 20 a message comprising a cryptogram signed by the token denoted WDMK′, the identifier of the second device 20 and/or of the user of the second device 20 as well as the identifier of the first device 10 and/or of the user of the first device 10 is transferred to the dematerialised payment platform 50.

The message comprises an application data field of the bank that comprises predetermined information indicating that the token WDMK′ has been transferred by a third party, in this case the user of the first device 10 in the present example. The predetermined information also indicates that the bank account of the user of the second device 20 must be debited and that the bank account of the user of the second device 20 must be credited and, optionally, the amount to be credited and debited.

At step E641, the dematerialised payment platform 50 reads the identifier of the first device 10 and/or of the user of the first device 10.

At step E642, the dematerialised payment platform 50 interrogates a database comprising information relating to the first device 10 and/or to the user of the first device 10.

The information relating to the first device 10 and/or to the user of the first device 10 makes it possible to obtain the information necessary for generating the token WDMK.

At step E643, the dematerialised payment platform 50 generates the token WDMK from the information obtained from the database.

At step E644, the dematerialised payment platform 50 determines, from the token WDMK generated at step E643, a token WDMK″ by effecting a symmetrical derivation of the token WDMK with the identifier of the second device 20 and/or of the user of the second device 20.

At step E645, the dematerialised payment platform 50 checks whether the cryptogram received and signed with the token WDMK′ and the cryptogram signed with the token WDMK″ are identical.

If the cryptograms are identical, the transaction is validated at step E647 and the account of the user of the first device 10 is debited while the account of the user of the second device 20 is credited.

If the cryptograms are different, the transaction is rejected at step E646.

FIG. 7a shows an example of an algorithm executed by the first device according to a third embodiment of the present invention.

When the user of the first device 10 wishes to make a payment for a service accessible by means of the second device 20, he controls the device 10 in order to establish at step E700 a secure channel between the first and second devices 10 and 20 by means of the NFC interfaces 205 and 305 or interfaces 204 and 304.

The secure channel is for example based on the sharing of the same symmetrical key to open a secure session of the SCP02 or SCP03 type.

At step E701, the first device 10 receives from the second device 20 at least one identifier of the second device 20 and/or of the user of the second device 20 by means of the secure channel.

At step E702, the first device 10 determines, from a token WDMK that it has, a new token WDMK′ by effecting a symmetrical key derivation of the token WDMK with the identifier of the second device 20 and/or of the user of the user of the second device 20.

At step E703, the first device 10 demands transfer of the token WDMK′ by means of the secure channel to the second device 20 as well as the identifier of the first device 10 and/or of the user of the first device 10.

FIG. 7b shows an example of an algorithm executed by the second device according to the third embodiment of the present invention.

When the user of the first device 10 wishes to make a payment for a service accessible by means of the second device 20, he controls the second device 20 to establish at step E720 a secure channel between the first and second devices 10 and 20 by means of the NFC interfaces 205 and 305 or interfaces 204 and 304.

The secure channel is for example based on the sharing of the same symmetrical key to open a secure session of the SCP02 or SCP03 type.

At step E721, at least one identifier of the second device 20 and/or of the user of the second device 20 is transferred to the first device 10 by means of the secure channel.

At step E722, a token denoted WDMK′ as well as at least one identifier of the first device 10 and/or of the user of the first device 10 is received by means of the secure channel.

At step E723, a message comprising a cryptogram signed by the token denoted WDMK′, the identifier of the second device 20 and/or of the user of the second device 20 as well as the identifier of the first device 10 and/or of the user of the first device 10 is transferred to the dematerialised payment platform 50.

The message comprises an application data field of the bank that comprises predetermined information indicating that the token WDMK′ has been transferred by a third party, in this case the user of the first device 10 in the present example. The predetermined information also indicates that the bank account of the user of the second device 20 must be debited.

FIG. 7c shows an example of an algorithm executed by the dematerialised payment platform according to the third embodiment of the present invention.

At step E740, the dematerialised payment platform 50 receives from the second device 20 a message comprising a cryptogram signed by the token denoted WDMK′, the identifier of the second device 20 and/or of the user of the second device 20 as well as the identifier of the first device 10 and/or of the user of the first device is transferred to the dematerialised payment platform 50.

The message comprises an application data field of the bank that comprises predetermined information indicating that the token WDMK′ has been transferred by a third party, in this case the user of the first device 10 in the present example. The predetermined information also indicates that the bank account of the user of the second device 20 must be debited.

At step E741, the dematerialised payment platform 50 reads the identifier of the first device 10 and/or of the user of the first device 10.

At step E742, the dematerialised payment platform 50 interrogates a database comprising information relating to the first device 10 and/or to the user of the first device 10.

The information relating to the first device 10 and/or to the user of the first device 10 makes it possible to obtain the information necessary for generating the token WDMK.

At step E743, the dematerialised payment platform 50 generates a token WDMK from the information obtained from the database.

At step E744, the dematerialised payment platform 50, from the token WDMK generated at step E743, determines a token WDMK″ by effecting a symmetrical key derivation of the token WDMK with the identifier of the second device 20 and/or of the user of the second device 20.

At step E745, the dematerialised payment platform 50 checks whether the cryptogram received and signed with the token WDMK′ and the cryptogram signed with the token WDMK″ are identical.

If the cryptograms are identical, the transaction is validated at step E6747 and the account of the user of the first device 10 is debited.

If the cryptograms are different, the transaction is rejected at step E742.

Naturally the present invention is in no way limited to the embodiments described here but quite the contrary encompasses any variant within the capability of a person skilled in the art.

1. A method for supplying a token in a host card emulation system comprising first and second devices and a secure payment platform, wherein the method comprises the steps of:
transferring by the second device to the first device of an identifier of the second device and/or of the user of the second device,
receiving from the first device by the second device of a first token and an identifier of the second device and/or of the user of the second device, the first token being a symmetrical derivation of a second token of the first device with the identifier of the second device and/or of the user of the second device,
transferring by the second device of a message comprising a cryptogram signed with the first token, the identifier of the first device and/or of the user of the first device and predetermined information indicating that the first token has been transferred by a third party,
receiving of the message by the dematerialised payment platform,
obtaining by the dematerialised payment platform information relating to the first device and/or of the user of the first device for generation of a third token of the first device,
generating a cryptogram by the dematerialised platform by executing a symmetrical key derivation of the third token generated by the dematerialised platform with the identifier of the second device and/or of the user of the second device,
accepting the bank transaction if the cryptograms are identical.

2. Method according to claim 1, wherein the message comprising the cryptogram signed with the first token is transferred to a retail outlet terminal that interrogates a server of a banking establishment that in its turn interrogates the dematerialised payment platform in order to verify the cryptogram.

3. Method according to claim 2, wherein the predetermined information indicating that the first token has been transferred by a third party also indicates that the account of the user of the second device must be debited.

4. Method according to claim 3, wherein the predetermined information indicating that the first token has been transferred by a third party further indicates that the account of the user of the second device must be debited and that the account of the user of the first device must be credited.

5. Method according to claim 4, wherein the predetermined information indicating that first token has been transferred by a third party further indicates the amount of debit and credit.

6. Method according to claim 1, wherein the method further comprises the step, executed prior to the step of transfer by the second device to the first device of an identifier of the second device and/or of the user of the second device, of creating a secure channel between the first device and the second device, and in that the identifier of the second device and the first token are transferred in the secure channel.

7. A system for supplying a token in a host card emulation system comprising first and second devices and a secure payment platform, wherein the system comprises:
means for transferring by the second device to the first device an identifier of the second device and/or of the user of the second device,
means for receiving from the first device by the second device a first token and an identifier of the second device and/or of the user of the second device, the first token being a symmetrical derivation of a second token of the first device with the identifier of the second device and/or of the user of the second device,
means for transferring by the second device a message comprising a cryptogram signed with the first token, the identifier of the first device and/or of the user of the first device and predetermined information indicating that the first token has been transferred by a third party,
means for receiving the message by the dematerialised payment platform,
means for obtaining by the dematerialised payment platform information relating to the first device and/or of the user of the first device for generation of a third token of the first device,
means for generating a cryptogram by the dematerialised platform by effecting a symmetrical key derivation of the third token generated by the dematerialised platform with the identifier of the second device and/or of the user of the second device,
means for the accepting the bank transaction if the cryptograms are identical.

8. System according to claim 7, characterised in that the first and second devices are smartphones.
